(19) United States
(12) Patent Application Publication
(10) Pub. No.: US 2005/0008532 A1
(43) Pub. Date: Jan. 13, 2005

(54) Method of inhibiting corrosion of copper plated or metallized surfaces and circuitry during semiconductor manufacturing processes

(76) Inventors: Brian V. Jenkins, Warrenville, IL (US); John E. Hoots, St. Charles, IL (US)

Correspondence Address: Michael B. Martin;Patent & Licensing Department, Ondeo Nalco Company, Ondeo Nalco Center, Naperville, IL, 60563-1198, US

(21) Appl. No.: 10/617,467

(22) Filed: Jul. 11, 2003

(51) Int. Cl. G05B 1/00

(52) U.S. Cl. 422/14; 422/7; 422/3; 422/292

(57) ABSTRACT

An treatment bath for use in the manufacture of copper plated or metallized semiconductor devices and a method of inhibiting corrosion of copper plated or metallized surfaces and circuitry in the semiconductor devices immersed in an aqueous fluid in a treatment bath comprising adding to the aqueous fluid an effective corrosion inhibiting amount of one or more aromatic triazole corrosion inhibitors; fluorometrically monitoring the concentration of aromatic triazole corrosion inhibitors in the aqueous fluid; and adding additional aromatic triazole corrosion inhibitor to the aqueous fluid to maintain an effective corrosion inhibiting concentration of the aromatic triazole corrosion inhibitor in the aqueous fluid.

### TECHNICAL FIELD

This invention relates to a method and apparatus for inhibiting corrosion of copper plated or metallized surfaces and circuitry in semiconductor devices immersed in water during semiconductor manufacturing processes using aromatic triazole corrosion inhibitors where the concentration of the corrosion inhibitor in the water is precisely monitored and controlled fluorometrically.

### BACKGROUND OF THE INVENTION

Semiconductor chip manufacturers use a variety of azoles to prevent in-process manufacturing corrosion of copper plated or metallized surfaces and circuitry in the semiconductor devices. Typically, at different points in the manufacturing process, the chips are immersed in treatment baths containing a solution of ultra pure water and azole corrosion inhibitor. Over time, the azole content of the solution can be depleted, for example by chemical/physical adsorption onto the copper plated or metallized surfaces and circuitry, biodegradation, or by incidental dilution of the inhibiting solution with water that does not contain correct azole levels. In addition, azoles adsorb onto the surface of the semiconductor devices. Thus, when the semiconductor devices are removed from the treatment bath and replaced, azole is removed with the devices from the treating system resulting in a removal of corrosion inhibitor from the system with no significant fluid loss. Additional azole is removed from the system, along with fluid due to the adherence of the fluid to the semiconductor devices.

Removal of azole through removal of copper-coated semiconductor devices is distinctive from traditional applications of azoles (such as open recirculating cooling water systems) where physical removal of treated surfaces from the system is not a routine occurrence.

Corrosion protection while the chips are immersed in the treatment bath is essential to ensure that the semiconductor devices will work as intended. Corroded metal surfaces will not function properly in manufactured integrated circuits (reduced “yield”) as compared to metal surfaces circuits that have been properly treated for corrosion inhibition. Thus, it is crucial that effective amounts of corrosion inhibitor be maintained in the aqueous treatment solution bath for the copper plated or metallized surfaces and circuitry in order to optimize the yield of the final integrated circuits and the manufacturing process as a whole.

Furthermore, it may be necessary to remove the azoles from the semiconductor device prior to certain downstream manufacturing processes, as the presence of the azole can interfere with those processes. Excessive feed of the azoles delays the removal processes and the subsequent manufacturing steps, causing a reduced output rate. Insufficient removal can cause yield problems. Finally, impurities including azoles must be removed from the water, or the azole dosage characterized and controlled, before the water can be discharged or recycled. Therefore, excessive dosing of azole is uneconomical.

Existing methods of determining the concentration of azoles in water include indirect methods such as calorimetric analysis which requires photolysis of a fluid sample and formation of a colored dimerization product and light absorbance methods which may be inaccurate at high or low azole concentrations. None of the foregoing methods provide for automatic or continuous control of azole concentration in the aqueous fluid.

Accordingly, there is an ongoing need for methods of inhibiting corrosion of copper plated or metallized surfaces and circuits in semiconductor devices that incorporates precise control of corrosion inhibitor concentration to ensure that a effective corrosion inhibition is maintained throughout the manufacturing process without overdosing of inhibitor.

### SUMMARY OF THE INVENTION

This invention is a method of inhibiting corrosion of copper plated or metallized surfaces and circuitry in semiconductor devices immersed in an aqueous fluid in a treatment bath comprising
(i) adding to the aqueous fluid an effective corrosion inhibiting amount of one or more aromatic triazole corrosion inhibitors;
(ii) fluorometrically monitoring the concentration of aromatic triazole corrosion inhibitors in the aqueous fluid; and
(iii) adding additional aromatic azole corrosion inhibitor to the aqueous fluid to maintain an effective corrosion inhibiting concentration of the aromatic triazole corrosion inhibitor in the aqueous fluid.

The present invention permits accurate and continuous control of aromatic triazole concentration within a specific concentration range in order to compensate for any processes leading to changes in triazole concentration during the manufacturing process or due to a desire by the operator to change triazole concentration at any point in the manufacturing process.

### BRIEF DESCRIPTION OF THE DRAWINGS

FIG. 1 is a working curve for benzotriazole showing fluorescence intensity versus benzotriazole concentration in aqeuous solution at benzotriazole doses of 0, 1, 5, 10, 25, 50, 250, 500 and 1,000 ppm.

FIG. 2 shows a typical treatment bath used in various manufacturing processes for copper plated or metallized semiconductor devices in which the semiconductor devices 5 are immersed in ultrapure water in a treatment bath 4 containing one or more fluid inlets 10 and fluid outlets 11. The treatment bath 4 includes means 16 such as a removable rack for supporting the semiconductor devices 5 in the treatment bath 4. Aromatic azole corrosion inhibitor solution contained in supply reservoir 1 is added into the treatment bath 4 using feeder line 2 through valve 3. Valve 3 may be replaced with or used in combination with a fluid addition pump (not shown). Fluid is circulated through the treatment bath 4 by pumping through fluid transfer lines 6 into the treatment bath 4 through inlets 10 and out of the treatment bath through outlets 11 using recirculating pump 7. Excess fluid resulting from addition of the aromatic azole corrosion inhibitor solution or other additives is removed from the system through drain or overflow pipe 8 which is opened or closed using valve 9.

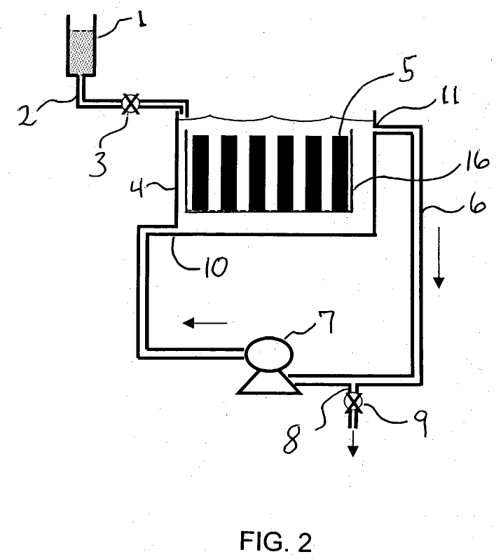

FIG. 3 shows an embodiment of this invention where the treatment bath 4 is equipped with means 12 for fluorometrically monitoring and controlling the concentration of aromatic azole corrosion inhibitors in the treatment bath where the monitoring and control means 12 are installed directly in a fluid transfer line 6.

FIG. 4 shows an alternative embodiment of this invention where the monitoring and control means 12 are disposed along a side stream sample line 13 connected to a treatment bath fluid transfer line 6 through pump 14.

### DETAILED DESCRIPTION OF THE INVENTION

This invention is a method of inhibiting corrosion of the copper plated or metallized surfaces and circuits in semiconductor devices while the devices are immersed in aqueous fluids in various stages of integrated circuit manufacturing processes. As used herein, “aqueous fluid” means ultrapure water, or ultrapure water containing alcohols, organic solvents, or other processing additives typically used in the manufacture of semiconductor devices.

“Semiconductor manufacturing process” or “integrated circuit manufacturing process” includes all processes employed in the manufacture of these devices, including, for example, photolithography, etching, plating, doping, polishing, metallizing, and the like.

According to this invention, aromatic triazole corrosion inhibitors are added to the aqueous fluid in an effective corrosion-inhibiting amount. The concentration of the inhibitors in the aqueous fluid is directly and accurately monitored fluorometrically such that additional aromatic triazole corrosion inhibitor can be added to replace corrosion inhibitor that is depleted or removed during the manufacturing process without detrimental or uneconomical overdosing of inhibitor.

Aromatic triazole corrosion inhibitors suitable for use in this invention include copper metal corrosion inhibitors comprising a triazole ring fused to an aromatic ring. Representative aromatic triazole corrosion inhibitors include benzotriazole, butylbenzotriazole, tolyltriazole, naphthotriazole, chlorobenzotriazole, bromobenzotriazole, chlorotolyltriazole, and bromotolyltriazole. “Tolyltriazole” includes 4-methylbenzotriazole and 5-methylbenzotriazole and mixtures thereof, including the mixtures disclosed in U.S. Pat. No. 5,503,775, incorporated herein by reference.

As used herein, “aromatic ring” means substituted and unsubstituted aromatic carbocyclic radicals and substituted and unsubstituted heterocyclic radicals having about 5 to about 14 ring atoms. Representative aryl include phenyl, naphthyl, phenanthryl, anthracyl, pyridyl, furyl, pyrrolyl, quinolyl, thienyl, thiazolyl, pyrimidyl, indolyl, and the like. The aryl is optionally substituted with one or more groups selected from hydroxy, halogen, C₁-C₄ alkyl, C₁-C₄ alkoxy, C₁-C₄ alkenyl, C₁-C₄ alkynyl, mercapto, sulfonyl, carboxyl, amino and amido. Preferred aromatic rings include phenyl and naphthyl.

“Alkoxy” means an alkyl group attached to the parent molecular moiety through an oxygen atom. Representative alkoxy groups include methoxy, ethoxy, propoxy, butoxy, and the like.

“Alkyl” means a monovalent group derived from a straight or branched chain saturated hydrocarbon by the removal of a single hydrogen atom. Representative alkyl groups include methyl, ethyl, n- and iso-propyl, n-, sec-, iso- and tert-butyl, and the like.

“Alkenyl” means a monovalent group derived from a hydrocarbon containing at least one carbon-carbon double bond by the removal of a single hydrogen atom. Representative alkenyl groups include ethenyl, propenyl, butenyl, 1-methyl-2-buten-1-yl, and the like.

“Alkynyl” means a monovalent group derived from a hydrocarbon containing at least one carbon-carbon triple bond by the removal of a single hydrogen atom. Representative alkynyl groups include ethynyl, propynyl, 1- and 2-butynyl, and the like.

“Amido” means a group of formula —C(O)NR′R″ where R′ and R″ are as defined herein. Representative amido groups include methylaminocarbonyl, ethylaminocarbonyl, isopropylaminocarbonyl and the like.

“Amino” means a group having the structure —NR′R″ wherein R′ and R″ are independently selected from H and C₁-C₄ alkyl. Representative amino groups include amino (NH₂), dimethylamino, diethylamino, methylethylamino, and the like.

“Carboxyl” means a group of formula —CO₂H.

“Halogen” means Br, Cl, F or I.

“Mercapto” means a group of formula —SR′ where R′ is defined herein. Representative mercapto groups include —SH, thiomethyl (—SCH₃), thioethyl (—SCH₂CH₃), and the like.

“Sulfonyl” means a group of formula —SO₃H.

Preferred aromatic triazole corrosion inhibitors are selected from the group consisting of benzotriazole, butylbenzotriazole, tolyltriazole and naphthotriazole. Benzotriazole, butylbenzotriazole, tolyltriazole are more preferred.

The aromatic triazole corrosion inhibitor is typically added as a solution in alcohol or as aqueous solution with one or more alcohols. Suitable alcohols include methanol, ethanol, isopropanol, ethylene glycol, propylene glycol, diethylene glycol, triethanol amine, and the like. Representative corrosion inhibitor solutions comprise about 0.001 to about 50 weight percent aromatic triazole corrosion inhibitor.

The aromatic triazole corrosion inhibitor is used in an amount sufficient to effectively prevent corrosion of the copper plated or metallized surfaces and circuitry of semiconductor devices without overdosing with inhibitor which then must be subsequently removed from the water. The dosage used is typically from about 1 ppm to about 1,000 ppm, preferably from about 10 ppm to about 1,000 ppm and more preferably from about 100 ppm to about 500 ppm.

The amount of aromatic triazole corrosion inhibitor in the aqueous treating fluid is monitored fluorometrically and additional inhibitor is added to the fluid to ensure that the aromatic triazole concentration in the fluid remains within the effective range as described above. The fluorimetric method is described briefly as follows.

The fluorescence intensity of the aqueous fluid using an excitation light source at the desired emission wavelength, is measured with a detector capable of measuring fluorescent light. Suitable excitation light sources include light sources capable of producing some light at the desired wavelength for aromatic triazoles. Representative excitation light sources include xenon flashlamps, continuous xenon lamps, tungsten-halogen lamps, deuterium lamps, deuterium-tungsten lamps, mercury vapor lamps, phosphor-coated mercury vapor lamps, mercury-argon lamps, and the like.

Acceptable detectors include, among others, photodiodes, phototransistors, photocells, photovoltaic cells, photomultiplier tubes, charge-coupled devices, and the like. The detector is selected based on its ability to detect light at the desired wavelength. Excitation and light sources and detectors are well known in the art and are commercially available from a variety of sources.

The measured fluorescence intensity is then compared to a working curve drawn up using standards in the concentration range of interest and this comparison provides a precise determination of the concentration of the corrosion inhibitor in the water sample drawn from the system.

Proper choice of excitation and emission wavelengths are essential to obtaining linearity and predictable results for fluorescence response to a range of aromatic triazole dosages. Table 1 shows selection of the excitation and emission wavelengths required to obtain a linear response for benzotriazole. If optical filters are chosen incorrectly, reduced linearity in fluorescence response over a narrower dosage range will occur (see Examples A-C below). In examples A-C, significant curvature of response curve at 100 ppm (due to non-optimal choice of optical filters) leads to higher readings than actually are present and would result in underfeeding of triazole. Example D is the best combination of excitation and emission wavelengths (leading to the best linearity over a broad range of concentrations) of the four examples shown in Table 1.

TABLE 1

| | Excitation | Emission | Benzotriazole Dosage |
|---|---|---|---|
| Example | Wavelength (nm) | Wavelength (nm) | 100 ppm reading* |
| A | 307 | 370 | 127 ppm |
| B | 310 | 370 | 115 ppm |
| C | 315 | 370 | 106 ppm |
| D | 320 | 370 | 102.6 ppm |

*Fluorometer calibrated at 0 ppm = 0 (distilled water) and 1000 ppm benzotriazole = 1000. For perfect linearity, 100 ppm benzotriazole dosage will read 100.

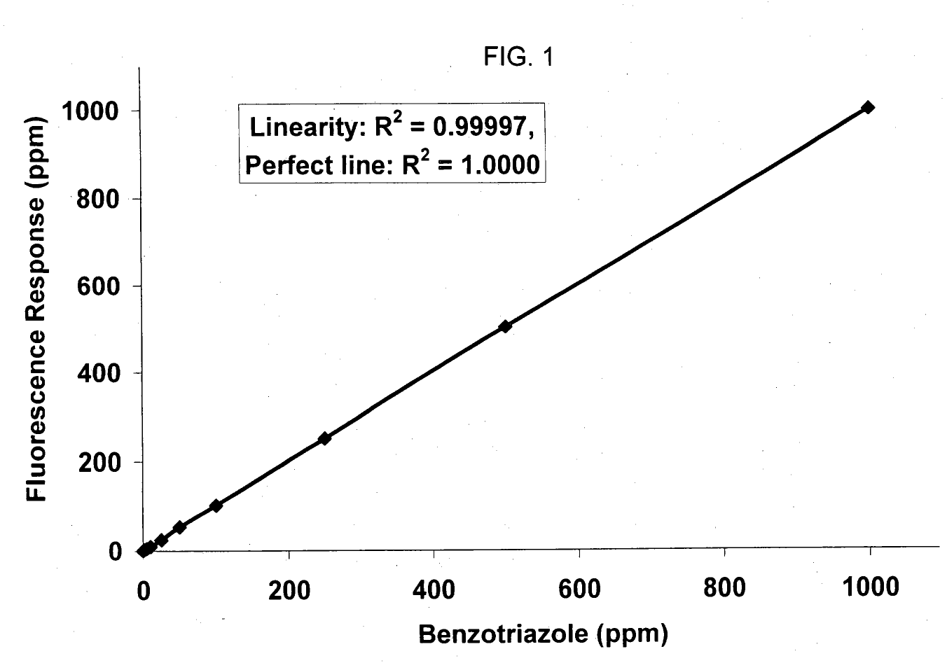

A working curve for benzotriazole (excitation wavelength 320 nm, emission wavelength 370 nm) is shown in FIG. 1. Similar curves can be readily created for any desired aromatic triazole when the fluorescence analysis conditions (for example, excitation and emission wavelength) are defined.

As shown above, the present fluorometric method requires the selection of an excitation wavelength to activate the fluorescence process and an emission wavelength at which the aromatic triazole corrosion inhibitor's fluorescence intensity is to be measured, which preferably is substantially free of interference from other species present in the aqueous fluid being monitored. Undesirable interference may be encountered when some other species has significant fluorescence emission about the emission wavelength selected for monitoring the given corrosion inhibitor.

The fluorescence behavior of benzotriazole at various pH values is shown in Table 2. The pH is measured using an Orion pH meter (Model 290A, Orion Research, Inc., Boston, Mass.) calibrated with VWR Scientific Products (West Chester, Pa.) standard buffers at pH 4 (potassium hydrogen phthalate buffer) and pH 10 (sodium bicarbonate/carbonate buffer). Benzotriazole solution is prepared by dissolving powdered benzotriazole in 50 mL of isopropyl alcohol and then diluting to a volume of 1 L with distilled water (final solution 95/5 vol/vol water/isopropyl alcohol). For a 1000 ppm benzotriazole solution, 1 g of benzotriazole is used to prepare 1 L of solution.

TABLE 2
pH versus Benzotriazole Concentration

| Benzotriazole (ppm) | pH |
|---|---|
| 0 | 8.2 |
| 10 | 5.7 |
| 100 | 5.0 |
| 1000 | 5.0 |

As shown in Table 2, a broad range of benzotriazole concentrations (10-1000 ppm) have a pH range (5.0-5.7) which are within the preferred pH operating range (pH 2-8) where pH has little or no effect on benzotriazole fluorescence as shown in Table 3.

The data in Table 3 are generated using a research-grade spectrofluorometer (Jobin Yvon-SPEX/Instruments S.A., Edison, N.J.). The following equipment set-up conditions are used: 0.3 cm×1 cm rectangular cuvette; 280 nm excitation wavelength; 320-450 nm emission wavelength range is scanned; Excitation/Emission slits=5 nm/5 nm. The proper choice of cuvette or flowcell pathlength in conjunction of proper choice of excitation and emission wavelength, as determined empirically using the methods described herein, is essential to obtaining acceptable results.

TABLE 3
Benzotriazole Fluorescence versus pH

| pH | Relative Fluorescence |
|---|---|
| 2.7 | 94% |
| 3.2 | 100% |
| 4.5 | 100% |
| 6.3 | 100% |
| 7.3 | 92% |
| 10.5 | 38% |

As shown in Table 3, the fluorescence intensity of benzotriazole is virtually unchanged (<10% difference in readings) between pH values ranging from pH ˜2.7 to pH 8. At pH values outside of that range, both the fluorescence intensity and wavelength of the maximum fluorescence signal change significantly.

As shown above, the pH of benzotriazole solutions (up to 1000 ppm) are mildly acidic and therefore fluorescence is not affected by changes in pH which may occur. Should pH values ever be encountered under strongly alkaline conditions, a fluorescence isoemission wavelength exists (325 nm) where the fluorescence of benzotriazole does not change significantly over a range which is broader than pH 2.7-10.5. The isoemission wavelength of benzotriazole is significantly different (325 nm) versus tolyltriazole (350 nm) and these results must be individually determined for each aromatic triazole so that proper choice of fluorescence analysis conditions can be made.

For high dosages of benzotriazole (hundreds of ppm), it is necessary to use longer wavelengths (320 nm for fluorescence excitation and 370 nm for fluorescence emission) to obtain linear fluorescence response to changes in triazole dosage as indicated in Table 1. As a result of the mildly acidic conditions in benzotriazole solutions, it is possible to use a longer fluorescence emission wavelength (370 nm) which provides good linear fluorescence response over a very broad range of pH conditions and benzotriazole concentration once the necessary operating and analysis conditions are properly understood, characterized, and chosen.

As indicated above for benzotriazole, obtaining acceptable results for monitoring and control of aromatic triazole dosage for an application area can depend on a complex combination of operating conditions and fluorescence analysis conditions. The necessary operating and analysis conditions can be determined for each individual aromatic triazole chemistry using the methods described above.

The fluorometric analysis described above is used to determine the concentration of aromatic triazole corrosion inhibitor present the aqueous fluid so that additional corrosion inhibitor can be added as required to maintain the effective corrosion inhibiting concentration.

The analysis can be conducted intermittantly, in which case a sample of the aqueous fluid is removed from the system for analysis or alternatively, a spectrofluorometer can be installed on-line for conducting the triazole analysis and dosage control at the desired intervals or continuously.

A dual monochromator spectrofluorometer can be used for a fluorimetric analysis conducted on an intermittent basis and for on-line and/or continuous fluorescence regulating. Portable or compact fluorometers equipped with appropriate excitation and emission filters and quartz flow through cells are commercially available, for instance from Ondeo Nalco Company, Naperville, Ill.

In a preferred aspect of this invention, the fluorometric analysis is conducted on a continuous basis.

In another preferred embodiment, the fluorometer comprises monitoring and control means for automatically and continuously monitoring the concentration of aromatic triazole corrosion inhibitor in the aqueous fluid and adjusting the concentration of corrosion inhibitor as required to maintain the desired effective corrosion inhibiting concentration.

The monitoring and control means typically includes a fluorometer for determining the concentration of aromatic triazole corrosion inhibitor in the water as described above, the flourometer including a transducer which generates an electrical signal corresponding to the inhibitor concentration and a feedback controller (monitor) connected to a fluid addition pump or valve for controlling the addition of aromatic triazole corrosion inhibitor contained in a reservoir, the pump to be activated and deactivated or the valve opened and closed, depending on a comparison of the concentration of corrosion inhibitor in the fluid, represented by the voltage signal from the transducer, to a voltage standard representing par performance of treating agent.

Methods of continuous monitoring and control of chemical additives are described in detail in U.S. Pat. Nos. 4,992,380 and 5,435,969, incorporated by reference.

A preferred fluorometer has xenon flashlamp light-source to provide a broad continuous range of excitation/emission wavelengths from 200-2000 nm. The Xenon flashlamp is preferably activated once-per-second and the fluorometer takes a fluorescence reading. Therefore response to changes in triazole dosage can start to occur after each second.

The optical filters (excitation and emission wavelengths) are preferably exchangeable in order to optimize the optical filters for the system being monitored/controlled. A preferred excitation optical filter is about 320 nm. The preferred emission optical filter is about 370 nm. Some flexibility in the optical wavelength values is acceptable (for example about 280 to about 320 nm excitation and about 360 to about 375 nm emission wavelengths) depending on the concentration range of aromatic triazole to be measured and controlled. Exchangeable optical filters are available, for example, from Andover Corporation, Salem, N.H.

Any type of detector may be suitably employed so long as it is sensitive in the emission wavelength range of the desired aromatic triazole corrosion inhibitor. A photodiode detector is preferred.

The fluorometer may also include a thermocouple to provide temperature-compensation for the effects of temperature on the fluorescence of the fluid sample. Such compensation may be necessary if the temperature of the fluid sample changes significantly, as certain aromatic triazoles such as triazole have a fairly large temperature coefficient.

The fluorometer preferably includes a series of alarms to determine when error conditions such as high corrosion inhibitor concentration, low corrosion inhibitor concentration, fluid addition pump on too long, low flow rate of sample, sample too hot, etc. have occurred. The alarms are associated with “failsafe” operation of dosage control whereby dosage is controlled on a timed basis when an alarm occurs.

The monitoring and control means may also include an output recording device or other register that generates a continuous record of triazole aromatic triazole corrosion inhibitor concentration as a function of time.

A preferred monitoring and control means is the TRASAR® Xe-2 Controller, available from Ondeo Nalco Company, Naperville, Ill.

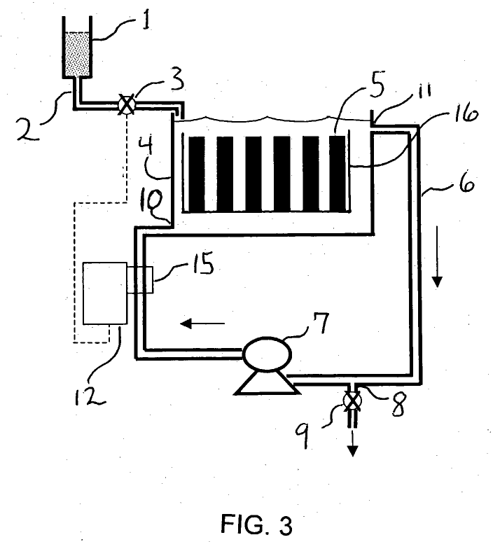

FIG. 3 shows an embodiment of this invention where the treatment bath 4 is equipped with means 12 for fluorometrically monitoring and controlling the concentration of aromatic triazole corrosion inhibitors in the treatment bath where the monitoring and control means 12 are disposed along the fluid transfer line 6. The monitoring and control means 12 include a flowcell 15 that is installed in the fluid transfer line 6 so that fluid circulating through the fluid transfer line 6 flows through the flowcell 15.

A preferred flowcell is a hollow fused quartz cylinder (tube) with an inner-diameter (ID) of about 3 mm and outer-diameter (OD) of about 5 mm with a wall thickness of about 1 mm. The fused quartz flowcell is about 8.5 cm long and has o-rings around each end to seal the flowcell to the flowcell housing to ensure no leakage of fluid from the sample being analyzed. Light from the fluorescence excitation light source shines through the flowcell and excites the aromatic triazole corrosion inhibitor in the aqueous fluid. The fluorescent emission light then shines through the flowcell and out to a detector.

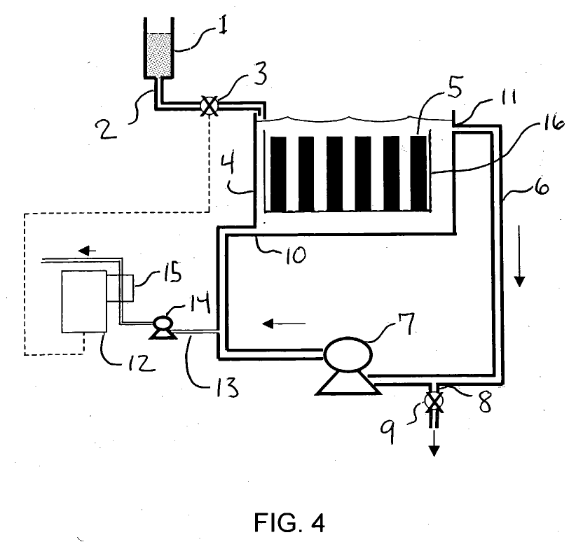

The control means generates a control signal, designated as a dashed line in FIGS. 3 and 4, that activates a valve 3 or fluid addition pump (not shown) disposed between the aromatic triazole corrosion inhibitor supply reservoir 1 and treatment bath 4. The control means automatically activates and deactivates the pump or opens and closes the valve to add corrosion inhibitor to maintain its concentration in the fluid in the desired concentration range.

Accordingly, in another aspect, this invention is a treatment bath for copper plated or metallized semiconductor devices comprising an inlet, an outlet, a fluid transfer line connecting said inlet and outlet for circulating aqueous fluid containing one or more aromatic triazole corrosion inhibitors through said treatment bath and fluid transfer line and monitoring and control means for fluorometrically determining the concentration of aromatic triazole corrosion inhibitor in the aqueous fluid, wherein the monitoring and control means comprise a flowcell installed in the fluid transfer line.

In a preferred aspect of this invention, the treatment bath further comprising a supply reservoir containing an aqueous solution of aromatic triazole corrosion inhibitor and a valve or pump for controlling the addition of the aqueous solution of aromatic triazole corrosion inhibitor to the treatment bath.

FIG. 4. Shows an embodiment of this invention where the monitoring and control means 12 are disposed along a side-stream sample line 13 connected to a treatment bath fluid transfer line 6 through a side-stream sample line 13 and pump 14. Pump 14 can be activated as necessary to provide a continuous or intermittant flow of fluid through a flowcell 15 installed in the side-stream sample line 13.

Accordingly, in another aspect, this invention is a treatment bath for copper plated or metallized semiconductor devices comprising an inlet, an outlet, a fluid transfer line connecting said inlet and said outlet for circulating an aqueous fluid containing one or more aromatic triazole corrosion inhibitors through said treatment bath and fluid transfer line, a side-stream sample line for removing a sample of aqueous fluid from the fluid transfer line and monitoring and control means for fluorometrically determining the concentration of aromatic triazole corrosion inhibitor in the aqueous fluid, wherein the monitoring and control means comprise a flowcell installed in the side-stream sample line.

As discussed herein, the aqueous treating fluid used in semiconductor device manufacturing processes comprises ultrapure water. In order to maintain the integrity of the manufacturing process, it is imperative that no impurities be released in to the aqueous treating fluid from the flowcell. The chemical compatibility of the fluorometer flowcell of this invention with ultrapure water is shown in Table 4.

TABLE 4
Chemical Compatibility of Fluorometer Flowcell and
Piping with Ultrapure Water Applications

| | | Composition of | | |
|---|---|---|---|---|
| | | Ultra-Pure Water Recirculated from | | |
| | | Reservoir thru Fluorometer Flowcell | | |
| | | | Final ppm | Change in ppm |
| Analyte | Expressed as | Initial (ppm) | (7 days) | after 7 days |
| Silica | as SiO2 | <0.017 | <0.017 | No change |
| Sodium | as Na | 0.02 | 0.017 | −0.003 |
| Calcium | as Ca | 0.006 | 0.046 | 0.040 |
| Magnesium | as Mg | <0.001 | 0.006 | 0.006 |
| Barium | as Ba | <0.020 | <0.020 | No change |
| Chromium | as Cr | <0.001 | <0.001 | No change |
| Copper | as Cu | <0.001 | <0.001 | No change |
| Iron | as Fe | 0.001 | <0.001 | No change |
| Potassium | As K | <0.030 | <0.030 | No change |
| Manganese | as Mn | <0.001 | <0.001 | No change |
| Molybdenum | as Mo | 0.02 | <0.001 | −0.02 ppm |
| Nickel | as Ni | <0.001 | <0.001 | No change |
| Lead | as Pb | <0.002 | <0.002 | No change |
| Zinc | as Zn | 0.002 | 0.012 | 0.010 |
| Chloride | as Cl | <0.002 | 0.044 | 0.042 |
| Nitrate | as NO3 | <0.004 | <0.004 | No change |
| Ortho- | as PO4 | <0.004 | <0.004 | No change |
| Phosphate | | | | |
| Sulfate | as SO4 | 0.012 | 0.023 | 0.011 |
| Fluoride | As F | <0.002 | <0.002 | No change |

The data in Table 4 show that most of the substances analyzed in the ultra-pure water show little or no change in composition after the ultrapure water is continuously recirculated from a liquid reservoir through the fluorometer flowcell for an extended period of time (7 days). In a few cases, the substances being analyzed decreased slightly (for example, molybdate level decreased by 0.02 ppm during this test). The concentration of only a few substances increased slightly during this study (for example, magnesium increased by 0.006 ppm). These small increases in chemcial concentration are not a concern for this application. This demonstrates that the fluorometer flowcell and materials of construction are compatible with this application in ultra-pure water.

Changes can be made in the composition, operation and arrangement of the method of the invention described herein without departing from the concept and scope of the invention as defined in the claims.

1. A method of inhibiting corrosion of copper plated or metallized surfaces and circuitry in semiconductor devices immersed in an aqueous fluid in a treatment bath comprising
(i) adding to the aqueous fluid an effective corrosion inhibiting amount of one or more aromatic triazole corrosion inhibitors;
(ii) fluorometrically monitoring the concentration of aromatic triazole corrosion inhibitors in the aqueous fluid; and
(iii) adding additional aromatic triazole corrosion inhibitor to the aqueous fluid to maintain an effective corrosion inhibiting concentration of the aromatic triazole corrosion inhibitor in the aqueous fluid.

2. The method of claim 1 wherein the aromatic triazole corrosion inhibitors are selected from the group consisting of benzotritriazole, butylbenzotritriazole, tolyltritriazole and naphthotritriazole.

3. The method of claim 1 wherein the aromatic triazole corrosion inhibitor is selected from the group consisting of benzotriazole, tolyltriazole and butylbenzotriazole.

4. The method of claim 1 wherein the effective corrosion inhibiting amount of triazole corrosion inhibitor is from about 1 ppm to about 1,000 ppm.

5. The method of claim 1 wherein the effective corrosion inhibiting amount of triazole corrosion inhibitor is from about 10 ppm to about 1,000 ppm.

6. The method of claim 1 wherein the effective corrosion inhibiting amount of triazole corrosion inhibitor is from about 100 ppm to about 500 ppm.

7. The method of claim 1 wherein the concentration of triazole corrosion inhibitor is measured intermittently.

8. The method of claim 1 wherein the concentration of triazole corrosion inhibitor is measured continuously.

9. The method of claim 1 wherein the treatment bath comprises an inlet, an outlet, a fluid transfer line connecting said inlet and outlet for circulating the aqueous fluid through said treatment bath and fluid transfer line and monitoring and control means for fluorometrically determining the concentration of aromatic triazole corrosion inhibitor in the aqueous fluid, wherein the monitoring and control means comprise a flowcell installed in the fluid transfer line.

10. The method of claim 9 wherein the monitoring is accomplished by introducing a sample of the aqueous fluid from the treatment bath into the flowcell and fluorometrically determining the concentration of the aromatic triazole corrosion inhibitor in the aqueous fluid in the flowcell.

11. The method of claim 10 wherein the aqueous fluid is continuously circulated through the flowcell and the concentration of aqueous triazole corrosion inhibitor is monitored continuously or intermittently.

12. The method of claim 9 wherein the treatment bath further comprises a supply reservoir containing an aqueous solution of aromatic triazole corrosion inhibitor and a valve or pump for controlling the addition of the aqueous solution of aromatic triazole corrosion inhibitor to the treatment bath.

13. The method of claim 12 wherein the monitoring and control means comprises a fluorometer for determining the concentration of aromatic triazole corrosion inhibitor in the aqueous fluid and a controller in communication with the valve or pump wherein the controller activates or deactivates the pump or opens or closes the valve based on the concentration of the aqueous aromatic corrosion inhibitor in the aqueous fluid.

14. The method of claim 1 wherein the treatment bath comprises an inlet, an outlet, a fluid transfer line connecting said inlet and outlet for circulating the aqueous fluid through said treatment bath and fluid transfer line, a side-stream sample line for removing a sample of aqueous fluid from the fluid transfer line and monitoring and control means for fluorometrically determining the concentration of aromatic triazole corrosion inhibitor in the aqueous fluid, wherein the monitoring and control means comprise a flowcell installed in the side-stream sample line.

15. The method of claim 14 wherein the monitoring is accomplished by introducing a sample of the aqueous fluid from the treatment bath into the flowcell and fluorometrically determining the concentration of the aromatic triazole corrosion inhibitor in the aqueous fluid in the flowcell.

16. The method of claim 14 wherein the treatment bath further comprises a supply reservoir containing an aqueous solution of aromatic triazole corrosion inhibitor and a valve or pump for controlling the addition of the aqueous solution of aromatic triazole corrosion inhibitor to the treatment bath.

17. The method of claim 16 wherein the monitoring and control means comprises a fluorometer for determining the concentration of aromatic triazole corrosion inhibitor in the aqueous fluid and a controller in communication with the valve or pump wherein the controller activates or deactivates the pump or opens or closes the valve based on the concentration of the aqueous aromatic corrosion inhibitor in the aqueous fluid.

18. A treatment bath for copper plated or metallized semiconductor devices comprising an inlet, an outlet, a fluid transfer line connecting said inlet and outlet for circulating aqueous fluid containing one or more aromatic triazole corrosion inhibitors through said treatment bath and fluid transfer line and monitoring and control means for fluorometrically determining the concentration of aromatic triazole corrosion inhibitor in the aqueous fluid, wherein the monitoring and control means comprise a flowcell installed in the fluid transfer line.

19. The treatment bath according to claim 9 further comprising a supply reservoir containing an aqueous solution of aromatic triazole corrosion inhibitor and a valve or pump for controlling the addition of the aqueous solution of aromatic triazole corrosion inhibitor to the treatment bath.

20. A treatment bath for copper plated or metallized semiconductor devices comprising an inlet, an outlet, a fluid transfer line connecting said inlet and said outlet for circulating an aqueous fluid containing one or more aromatic triazole corrosion inhibitors through said treatment bath and fluid transfer line, a side-stream sample line for removing a sample of aqueous fluid from the fluid transfer line and monitoring and control means for fluorometrically determining the concentration of aromatic triazole corrosion inhibitor in the aqueous fluid, wherein the monitoring and control means comprise a flowcell installed in the side-stream sample line.

21. The treatment bath according to claim 20 further comprising a supply reservoir containing an aqueous solution of aromatic triazole corrosion inhibitor and a valve or pump for controlling the addition of the aqueous solution of aromatic triazole corrosion inhibitor to the treatment bath.
